(19) United States
(12) Patent Application Publication
(10) Pub. No.: US 2026/0339347 A1
(43) Pub. Date: Oct. 29, 2026

(54) NETWORK CONNECTED UNIVERSAL PAYLOAD ASSEMBLY FOR MULTI-ROTOR PLATFORMS

(71) Applicant: Moog Inc., East Aurora, NY (US)

(72) Inventor: Michael Brunner, East Aurora, NY (US)

(21) Appl. No.: 19/118,455

(22) PCT Filed: Sep. 19, 2023
(86) PCT No.: PCT/US2023/074572

§ 371 Date: Apr. 4, 2025

Related U.S. Application Data
(60) Provisional application No. 63/378,723, filed on Oct. 7, 2022.

(51) Int. Cl. G05D 1/667; B64D 1/22; G05D 1/226; G05D 1/229; G05D 109/25; G05D 111/30

(52) U.S. Cl. CPC G05D 1/667; B64D 1/22; G05D 1/226; G05D 1/229; G05D 2109/25; G05D 2111/34

(57) ABSTRACT

A method for carrying a payload (150) using a multi-rotor flight vehicle (MRFV) (130), including receiving an indication that the payload (150) is connected to the MRFV (130), receiving an input from the payload (150), determining, from the input, data related to the payload (150), and sending the data to a remote location (120).

### CROSS-REFERENCE TO RELATED APPLICATIONS

This application claims the benefit under Articles 4 and 8 of the Stockholm Act of the Paris Convention for the Protection of Industrial Property of U.S. Patent Application No. 63/378,723, filed on Oct. 7, 2022, which application is incorporated herein by reference in its entirety.

### TECHNICAL FIELD

The present disclosure relates generally to multi-rotor flight vehicles, and more particularly, to a universal payload assembly for a multi-rotor flight vehicle that removably connects to and communicates with various payload types.

### BACKGROUND ART

A multirotor, multicopter, or multi-rotor flight vehicle is a rotorcraft with more than two lift-generating rotors. An advantage of a multi-rotor flight vehicle is the simpler rotor mechanics required for flight control. Unlike single- and double-rotor helicopters which use complex variable pitch rotors whose pitch varies as the blade rotates for flight stability and control, multi-rotor flight vehicles often use fixed-pitch blades, wherein control of vehicle motion is achieved by varying the relative speed of each rotor to change the thrust and torque produced by each. Due to their ease of both construction and control, multi-rotor flight vehicles are frequently used in radio control aircraft and unmanned aerial vehicle (UAV) (drone) projects in which the names tricopter, quadcopter, hexacopter, and octocopter are frequently used to refer to 3-, 4-, 6- and 8-rotor rotorcraft, respectively. There is also the X8 (also called octo-quad) configuration that is similar to the quadracopter design, except that it has eight rotors; the lower of which have a reversed rotation direction.

Since multi-rotor flight vehicles are typically unmanned, current designs do not allow for confirmation of connection to a payload or detection of payload information.

### BRIEF SUMMARY

With parenthetical reference to corresponding parts, portions or surfaces of the disclosed embodiment, merely for the purposes of illustration and not by way of limitation, the present disclosure provides a method for carrying a payload (150) using a multi-rotor flight vehicle (MRFV) (130), comprising receiving an indication that the payload (150) is connected to the MRFV (130), receiving an input from the payload (150), determining, from the input, data related to the payload (150), and sending the data to a remote location.

The step of receiving the indication that the payload (150) is connected to the MRFV (130) may comprise receiving a signal from one or more sensors that a first coupler (154) of the payload (150) is connected to a second coupler (136) of the MRFV (130). The input may comprise one or more codes. The data related to the payload (150) may include a payload type. The data related to the payload (150) may include a payload status. The data related to the payload (150) may include a payload specific command/control task.

The step of receiving the input from the payload (150) may comprise receiving the input via wireless transmission. The step of receiving the input from the payload (150) may comprise receiving the input from a radio frequency identification tag (160) arranged on the payload (150). The step of sending the data to a remote location may comprise sending the data to the remote location using a tactical data link. The tactical data link may comprise Link 16. The tactical data link may comprise joint all-domain command and control (JADC2).

In another aspect, the present disclosure provides a universal payload assembly system (100), comprising a flight vehicle (130), including one or more computer processors (304), one or more computer readable storage media (306, 308), and program instructions stored on the computer readable storage media (306, 308) for execution by at least one of the one or more computer processors (304), the program instructions comprising program instructions to receive an indication that a payload (150) is connected to the flight vehicle (130), program instructions to receive an input from the payload (150), program instructions to determine, from the input, data related to the payload (150), and program instructions to send the data to a remote location.

The flight vehicle (130) may be a multi-rotor flight vehicle. The flight vehicle (130) may be an unmanned multi-rotor flight vehicle. The flight vehicle (130) may further comprise a first uniform mechanical coupler (136). The program instructions to receive an indication that the payload (150) is connected to the flight vehicle (130) may comprise program instructions to determine that the first uniform mechanical coupler (136) is connected to a second uniform mechanical coupler (154) of the payload (150). The second uniform mechanical coupler (154) may correspond to the first uniform mechanical coupler (136). The data related to the payload (150) may include a payload type. The data related to the payload (150) may include at least one of a payload type, a payload status, and a payload specific command/control task. The program instructions to receive the input from the payload (150) may comprise program instructions to receive the input via wireless transmission. The program instructions to receive the input from the payload (150) may comprise program instructions to receive the input from a radio frequency identification tag (160) arranged on the payload (150). The program instructions to send the data to a remote location may comprise program instructions to send the data to the remote location using a tactical data link.

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE DRAWINGS

Various embodiments are disclosed, by way of example only, with reference to the accompanying schematic drawings below in which corresponding reference symbols indicate corresponding parts.

FIG. 1 is a functional block diagram illustrating an environment, in accordance with some embodiments of the present disclosure.

FIG. 2 is a block diagram of a universal payload assembly for a multi-rotor flight vehicle (MRFV).

FIG. 3 is an elevational view of an embodiment of a MRFV arranged for use with the universal payload assembly.

FIG. 4 is a perspective view of a suspension lug.

FIG. 5 is a perspective view of a MRFV connected to a payload.

FIG. 6 is a perspective view of a MRFV connected to an alternate payload.

FIG. 7 is a perspective view of a MRFV connected to a second alternate payload.

FIG. 8 is a perspective view of a MRFV connected to a third alternate payload.

FIG. 9 is a flow chart depicting operational steps for carrying a payload.

FIG. 10 is a block diagram of internal and external components of a computer system, in accordance with an embodiment of the present disclosure.

### DETAILED DESCRIPTION OF THE EMBODIMENTS

At the outset, it should be clearly understood that like reference numerals are intended to identify the same structural elements, portions, or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal,” “vertical,” “left,” “right,” “up” and “down,” as well as adjectival and adverbial derivatives thereof (e.g., “horizontally,” “rightwardly,” “upwardly,” etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

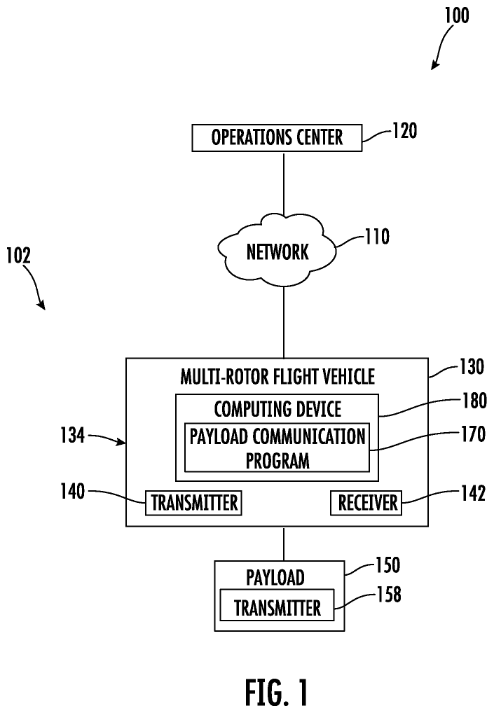

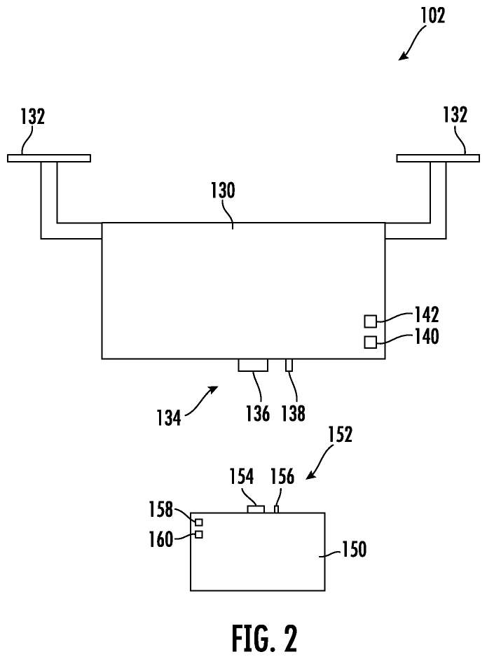

Adverting now to the figures, FIG. 1 is a functional block diagram illustrating a universal payload assembly system or environment, generally designated 100, in accordance with some embodiments of the present disclosure. FIG. 1 provides only an illustration of one implementation, and does not imply any limitations with regard to the environments in which different embodiments may be implemented. Many modifications to the depicted environment may be made by those skilled in the art without departing from the scope of the disclosure as recited by the claims. In an exemplary embodiment, environment 100 includes universal payload assembly 102 and operations center 120, both being connected to network 110. FIG. 2 is a block diagram of universal payload assembly 102. Universal payload assembly 102 generally comprises MRFV 130 and at least one payload, for example, payload 150.

Network 110 can be, for example, a local area network (LAN), a metropolitan area network (MAN), a wide area network (WAN) such as the Internet, or a combination of thereof, and can include wired, wireless, or fiber optic connections.

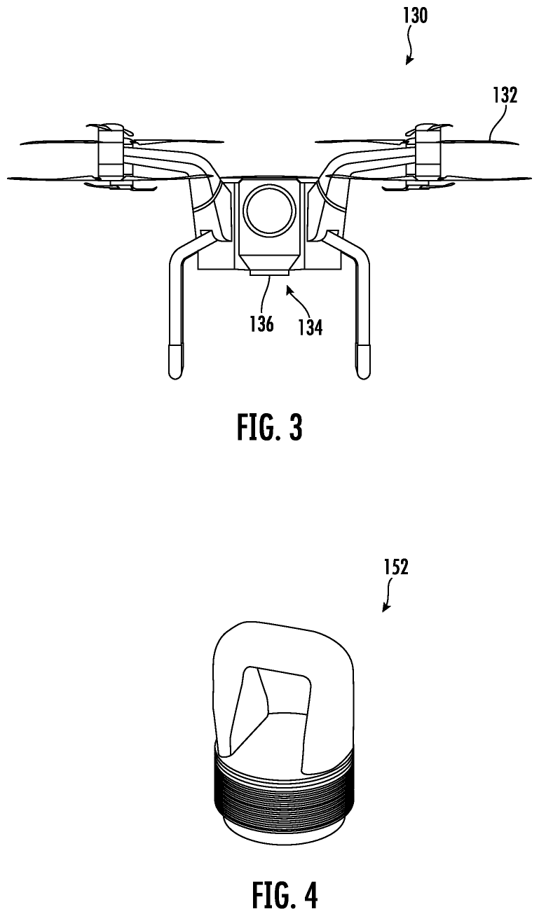

MRFV 130 generally comprises a plurality of rotors or propellors 132 and coupling assembly 134. Coupling assembly 134 is a universal payload interface operatively arranged to secure different types of payloads to MRFV 130 that have a corresponding coupling. In an exemplary embodiment, coupling assembly 134 comprises coupler 136 arranged to releasably secure payload 150 to MRFV 130. FIG. 3 shows an example embodiment of MRFV 130. In an exemplary embodiment, coupling assembly 134 further comprises port or connector 138. Connector 138 is a physical communications port arranged to facilitate wired communication between payload 150 and MRFV 130. For example, connector 138 may comprise a MIL-DTL-38999 connector. In an exemplary embodiment, MRFV 130 further comprises transmitter 140 and receiver 142. Transmitter 140 is arranged to transmit data related to MRFV 130 and/or payload 150, for example, to operations center 120 via network 110. Receiver 142 is arranged to receive data from MRFV 130 and/or operations center 120. For example, MRFV 130 may receive, via receiver 142, data from payload 130 related to payload type, payload status, and payload specific command/control tasks. MRFV 130 may receive this data from payload 150 via a wired connection, as previously described, or a wireless connection. In an exemplary embodiment, payload 150 comprises transmitter 158 arranged to transmit data to MRFV 130. In an exemplary embodiment, MRFV 130 receives data from payload 150 via radio frequency identification (RFID). For example, MRFV 130 may comprise a RFID reader device that sends an electromagnetic interrogation pulse to RFID tag 160 of payload 150. In an exemplary embodiment, MRFV 130 further comprises a base platform.

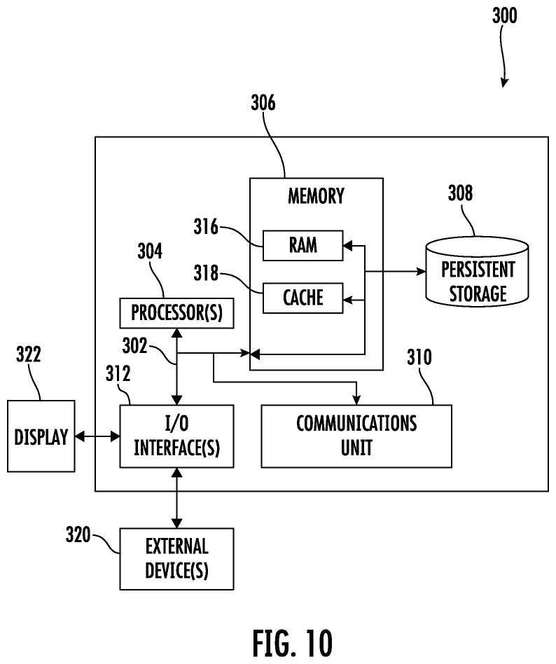

MRFV 130 further comprises computing device 180. Computing device 180 may be a hardware device that detects information related to a payload secured to MRFV 130 and communicates the detected information to a remote operator, for example at operations center 120, using payload communication program 170. Computing device 180 is capable of communicating with network 110, payload 150, and operations center 120. In an exemplary embodiment, computing device 180 may include a computer. In an exemplary embodiment, computing device 180 may include internal and external hardware components, as depicted and described in further detail with respect to FIG. 10. In an exemplary embodiment, payload communication program 170 is implemented on a web server, which may be a management server, a web server, or any other electronic device or computing system capable of receiving and sending data. The web server can represent a computing system utilizing clustered computers and components to act as a single pool of seamless resources when accessed through a network. The web server may include internal and external hardware components, as depicted and described in further detail with respect to FIG. 10.

Payload 150 comprises coupling assembly 152. Coupling assembly 152 is a universal payload interface. In an exemplary embodiment, coupling assembly 152 comprises standardized connector 154 (e.g., a 14 inch NATO suspended lug) to facilitate easy connection to coupling assembly 134. An example of a suspended lug is shown in FIG. 4. In an exemplary embodiment, payload 150 further comprises connector or port 156 to facilitate wired connection to MRFV 130. In an exemplary embodiment, connector 138 may comprise a MIL-DTL-38999 connector. In an exemplary embodiment, payload 150 comprises transmitter 158 arranged to transmit data related to payload 150 to MRFV 130 via wired connection (i.e., using connectors 138 and 156) or wirelessly (e.g., BLUETOOTH® communication, 3G, 4G, or 5G network, infrared communication, near field communication, ultraband communication, ZIGBEE® commination, satellite communications, proprietary license band radios, etc.). Proprietary license band radios may be used to increase the immunity of control communications from disturbances by other users using the band width for other purposes. In an exemplary embodiment, payload 150 comprises RFID tag 160 arranged to contain and transmit data related to payload 150 to MRFV 130.

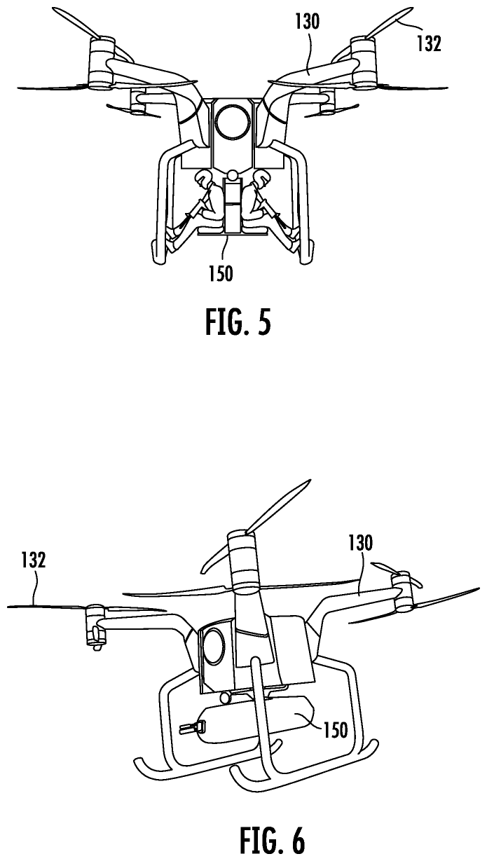

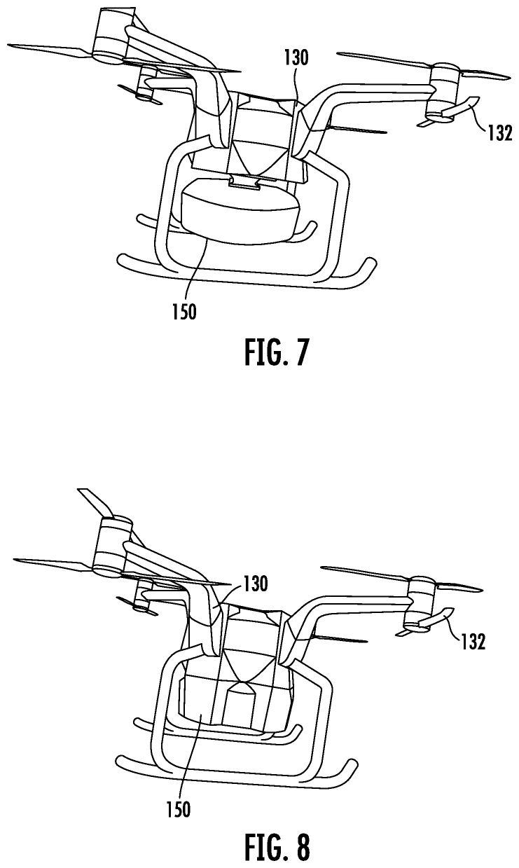

MRFV 130 is arranged to secure and transport various payload types, and since MRFV 130 is unmanned or autonomous, the remote operator or program controlling MRFV 130 needs information related to the payload. FIGS. 5-8 show various payload types having a corresponding connector connected to MRFV 130. FIG. 5 shows a perspective view of MRFV 130 securing infiltration/exfiltration payload 150, which is operatively arranged to transport living humans (e.g., soldiers). FIG. 6 shows a perspective view of MRFV 130 securing gun pod payload 150, which is operatively arranged to fire ammunition. FIG. 7 shows a perspective view of MRFV 130 securing a tank payload 150, for example, water, fire suppression, fuel, pesticides, etc.). FIG. 8 shows a perspective view of MRFV 130 securing a conformal payload 150, which is operatively arranged to fit closely to the profile of MRFV 130 to reduce drag. Although not shown, it should be appreciated that other payload types may be used, for example, a bomb release payload, a missile launcher payload, package carrier and delivery payload, casualty evacuation, medical supply (e.g., organs, blood, etc.) delivery payload, portable electric power supply, a critical communications relay, etc.

Universal payload assembly environment 100 facilitates attachment, monitoring, and control of payload 150 when connected to MRFV 130. In an exemplary embodiment, MRFV 130 is an unmanned or autonomous vehicle that is controlled remotely, for example, by an operator at operations center 120. Universal payload assembly environment 100 allows for rapid reconfigurability of MRFV 130 (i.e., for connection to different types of payloads), payload recognition including payload type and mission, payload monitoring, and command and control utilizing a secure tactical data link (TDL) and a network (e.g., a unified control network). In an exemplary embodiment, universal payload assembly 102 provides a secured connection between MRFV 130 and network 110. Universal payload assembly 102 incorporates limitless payload capable for, for example, utility, weapons, resupply, exfiltration seating, etc. Universal payload assembly 102 also provides interconnectivity through a secure TDL, allowing command, control, and status communication within unified network 110.

Universal payload assembly environment 100 is operatively arranged to connect to any payload including coupler 154 (e.g., 14 inch suspension lugs) and securely fasten payload 150 to MRFV 130. Once suspended from MRFV 130, payload 150 communicates data related to payload 150, including at least one of payload type, payload status, and payload specific command/control tasks, to MRFV 130 and/or from MRFV 130 to payload 150 (i.e., communications and commands may be sent to payload 150 from MRFV 130 for deployment of payload 150). Communication between payload 150 and MRFV 130 may occur via wired connection, RFID, or any other wireless protocol to provide real-time, two way communication of payload data to and from the operator. Commination between MRFV 130 with the operator (i.e., at operations center 120) may occur through a modular open system architecture (MOSA) compliant, TDL, for example, Link 16 and/or joint all-domain command and control (JADC2).

It should be appreciated that in an exemplary embodiment, universal payload assembly 102 is a subassembly or subassemblies arranged to be connected to or arranged in at least one of MRFV 130 and payload 150. For example, a universal payload assembly 102 comprising coupler 136, transmitter 140, receiver 142, and payload communication program 170 can be installed on/in MRFV 130. In an exemplary embodiment, a universal payload assembly 102 comprising coupler 154 and at least one of transmitter 158 and RFID tag 160 may installed on/in payload 150. Moreover, it should be further appreciated that, while shown herein assembled on a MRFV, universal payload assembly 102 could be arranged on other aerial vehicles, for example, single rotor flight vehicles, fixed wing aircraft, and the like.

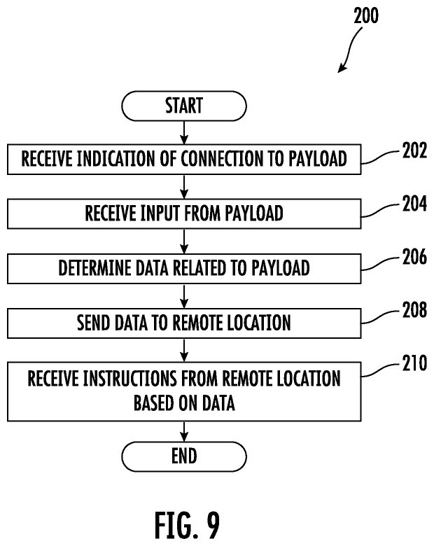

FIG. 9 shows a flow chart 200 depicting operational steps for carrying payload 150, in accordance with some embodiments of the present disclosure. It should be appreciated that payload communication program 170 can be operated by an operator or automatically.

In step 202, payload communication program 170 receives an indication that payload 150 is connected to MRFV 130. In an exemplary embodiment, the communication of connection to payload 150 is received from one or more sensors detecting a successful engagement of coupler 154 with coupler 136. In an exemplary embodiment, the communication of connection to payload 150 is received from transmitter 158 of payload 150.

In step 204, payload communication program 170 receives an input from payload 150 including data related to payload 150. As previously described, the input can be received from payload 150 wirelessly (i.e., transmitter 158 and/or RFID tag 160) or via wired connection (i.e., connectors 156 and 138). The input includes data related to payload 150 or one or more codes that can be used to received data related to payload 150. The data may include the payload type, for example, ordnance or weapons, passenger seating, water tank, fire suppression materials or equipment, medical supplies or other supplies, fuel, etc. The data may include weight, intended destination, altitude restrictions, deployment restrictions or limitations, status, specific command/control tasks, etc. of payload 150.

In step 206, payload communication program 170 determines the data related to payload 150. For example, if in step 204 communication program 170 receives one or more inputs from payload 150 in the form of code, payload communication program 170 will then decode the input and/or determine the payload data therefrom. In an exemplary embodiment, payload commination program 170 compares the one or more codes received in the input to codes in a database to determine data related to payload 150. In an exemplary embodiment, payload communication program 170 sends the input received from payload 150 to operations center 120, and an operator at operations center 120 retrieves relevant data related to payload 150.

In step 208, payload communication program 170 sends data related to payload 150 to a remote location, for example, operations center 120. This data can be used by the operator in order to carry out the best flight plan. For example, if payload 150 comprises passenger seating (and thus passengers), the operator knows not to jettison payload 150 for any reason. If payload 150 comprises fire retardant, the operator knows to drop at or above a predetermined altitude (e.g., 100 feet above the vegetation).

In step 210, payload communication program 170 receives instructions from remote location, for example, operations center 120, based on the data. For example, based on the data related to payload 150, operations center 120 may send instructions to MRFV 130 regarding deployment of payload 150 or the flight plan. Some examples of instructions include, but are not limited to, instructions regarding a final destination for MRFV 130 to deliver payload 150, instructions to alert passengers of payload 150 when to exit the vehicle, instructions regarding altitude, and instructions regarding a munitions firing time and/or direction.

FIG. 10 is a block diagram of internal and external components of computing device 300, which is representative of the computing device of FIG. 1, in accordance with an embodiment of the present disclosure. It should be appreciated that FIG. 10 provides only an illustration of one implementation and does not imply any limitations with regard to the environments in which different embodiments may be implemented. In general, the components illustrated in FIG. 10 are representative of any electronic device capable of executing machine-readable program instructions. Examples of computer systems, environments, and/or configurations that may be represented by the components illustrated in FIG. 10 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 300 includes communications fabric 302, which provides for communications between one or more processing units 304, memory 306, persistent storage 308, communications unit 310, and one or more input/output (I/O) interfaces 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 316 and cache memory 318. In general, memory 306 can include any suitable volatile or non-volatile computer readable storage media. Software is stored in persistent storage 308 for execution and/or access by one or more of the respective processors 304 via one or more memories of memory 306.

Persistent storage 308 may include, for example, a plurality of magnetic hard disk drives. Alternatively, or in addition to magnetic hard disk drives, persistent storage 308 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 308 can also be removable. For example, a removable hard drive can be used for persistent storage 308. Other examples include optical and magnetic disks, thumb drives, and smart cards that are inserted into a drive for transfer onto another computer readable storage medium that is also part of persistent storage 308.

Communications unit 310 provides for communications with other computer systems or devices via a network. In this exemplary embodiment, communications unit 310 includes network adapters or interfaces such as a TCP/IP adapter cards, wireless Wi-Fi interface cards, or 3G, 4G, or 5G wireless interface cards or other wired or wireless communications links. The network can comprise, for example, copper wires, optical fibers, wireless transmission, routers, firewalls, switches, gateway computers and/or edge servers. Software and data used to practice embodiments of the present disclosure can be downloaded to computing device 300 through communications unit 310 (i.e., via the Internet, a local area network, or other wide area network). From communications unit 310, the software and data can be loaded onto persistent storage 308.

One or more I/O interfaces 312 allow for input and output of data with other devices that may be connected to computing device 300. For example, I/O interface 312 can provide a connection to one or more external devices 320 such as a keyboard, computer mouse, touch screen, virtual keyboard, touch pad, pointing device, or other human interface devices. External devices 320 can also include portable computer readable storage media such as, for example, thumb drives, portable optical or magnetic disks, and memory cards. I/O interface 312 also connects to display 322.

Display 322 provides a mechanism to display data to a user and can be, for example, a computer monitor. Display 322 can also be an incorporated display and may function as a touch screen, such as a built-in display of a tablet computer.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In an exemplary embodiment, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The processing and management computing devices may include a communications interface. The communications interface allows software and data to be transferred between the computing device and external devices. The communications interface may include a modem, a network interface (such as an Ethernet card), a communications port, a PCMCIA slot and card, or other means to couple the computing device to external devices. Software and data transferred via the communications interface may be in the form of signals, which may be electronic, electromagnetic, optical, or other signals capable of being received by the communications interface. These signals may be provided to the communications interface via wire or cable, fiber optics, a phone line, a cellular phone link, and radio frequency link or other communications channels. In some embodiments, a device or component is “coupled” to a computing device if it is so related to that device that the product or means and the device may be operated together as one machine. In particular, a piece of electronic equipment is coupled to a computing device if it is incorporated in the computing device, attached to the device by wires capable of propagating signals between the equipment and the device, tethered to the device by wireless technology that replaces the ability of wires to propagate signals, or related to the computing device by shared membership in some network consisting of wireless and wired connections between multiple machines. A computing device may be coupled to a second computing device; for instance, a server may be coupled to a client device. The communications interface in the system embodiments discussed herein facilitates the coupling of the computing device with data entry devices such as GPS and network connections, whether wired or wireless. In some embodiments, “data entry devices” are any equipment coupled to a computing device that may be used to enter data into that device. This definition includes, without limitation, keyboards, computer mice, touchscreens, digital cameras, digital video cameras, wireless antennas, GPS devices, gyroscopic orientation sensors, proximity sensors, compasses, scanners, and specialized reading devices, and any hardware device capable of sensing electromagnetic radiation, electromagnetic fields, gravitational force, electromagnetic force, temperature, vibration, pressure, air speed and the like. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. As discussed above, the processing and management computing devices may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers.

A code scanner coupled to a computing device is a device that can extract information from a “code” attached to an object. In one embodiment, a code contains data concerning the object to which it is attached that may be extracted automatically by a scanner; for instance, a code may be a bar code whose data may be extracted using a laser scanner. A code may include a quick response (QR) code whose data may be extracted by a digital scanner or camera. A code may include a RFID tag; the code may include an active RFID tag. The code may include a passive RFID tag. A computing device may also be coupled to a code exporter; in an embodiment, a code exporter is a device that can put data into a code. For instance, where the code is a two-dimensional image printed on paper, or a three dimensional printed object, or another object, the code exporter may be a printer. Where the code is a non-writable RFID tag, the code exporter may be a device that can produce a non-writable RFID tag. Where the code is a writable RFID tag, the code exporter may be an RFID writer; the code exporter may also be a code scanner, in some embodiments. In some embodiments, a computing device's “display” is a device coupled to the computing device, by means of which the computing device can display images. Display include without limitation monitors, screens, television devices, and projectors.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

What is claimed is:

1. A method for carrying a payload using a multi-rotor flight vehicle (MRFV), comprising:
receiving an indication that the payload is connected to the MRFV;
receiving an input from the payload;
determining, from the input, data related to the payload; and
sending the data to a remote location.

2. The method as recited in claim 1, wherein the step of receiving the indication that the payload is connected to the MRFV comprises:
receiving a signal from one or more sensors that a first coupler of the payload is connected to a second coupler of the MRFV.

3. The method as recited in claim 1, wherein the input comprises one or more codes.

4. The method as recited in claim 1, wherein the data related to the payload includes a payload type.

5. The method as recited in claim 1, wherein the data related to the payload includes a payload status.

6. The method as recited in claim 1, wherein the data related to the payload includes a payload specific command/control task.

7. The method as recited in claim 1, wherein the step of receiving the input from the payload comprises:
receiving the input via wireless transmission.

8. The method as recited in claim 1, wherein the step of receiving the input from the payload comprises:
receiving the input from a radio frequency identification tag arranged on the payload.

9. The method as recited in claim 1, wherein the step of sending the data to a remote location comprises:
sending the data to the remote location using a tactical data link.

10. The method as recited in claim 9, wherein the tactical data link comprises Link 16.

11. The method as recited in claim 9, wherein the tactical data link comprises joint all-domain command and control (JADC2).

12. A universal payload assembly system, comprising:
a flight vehicle, including:
one or more computer processors;
one or more computer readable storage media; and
program instructions stored on the computer readable storage media for execution by at least one of the one or more computer processors, the program instructions comprising:
program instructions to receive an indication that a payload is connected to the flight vehicle;
program instructions to receive an input from the payload;
program instructions to determine, from the input, data related to the payload; and
program instructions to send the data to a remote location.

13. The universal payload assembly system as recited in claim 12, wherein the flight vehicle is a multi-rotor flight vehicle.

14. The universal payload assembly system as recited in claim 12, wherein the flight vehicle further comprises a first uniform mechanical coupler.

15. The universal payload assembly system as recited in claim 14, wherein the program instructions to receive an indication that the payload is connected to the flight vehicle comprise:
program instructions to determine that the first uniform mechanical coupler is connected to a second uniform mechanical coupler of the payload.

16. The universal payload assembly system as recited in claim 12, wherein the data related to the payload includes a payload type.

17. The universal payload assembly system as recited in claim 12, wherein the data related to the payload includes at least one of a payload type, a payload status, and a payload specific command/control task.

18. The universal payload assembly system as recited in claim 12, wherein the program instructions to receive the input from the payload comprise:
program instructions to receive the input via wireless transmission.

19. The universal payload assembly system as recited in claim 12, wherein the program instructions to receive the input from the payload comprise:
program instructions to receive the input from a radio frequency identification tag arranged on the payload.

20. The universal payload assembly system as recited in claim 12, wherein the program instructions to send the data to a remote location comprise:
program instructions to send the data to the remote location using a tactical data link.
